(19) United States
(12) Patent Application Publication
(10) Pub. No.: US 2013/0321452 A1
(43) Pub. Date: Dec. 5, 2013

(54) SYSTEM AND METHOD FOR PROTECTING THE PRIVACY OF OBJECTS RENDERED ON A DISPLAY

(71) Applicants: Amit Nishikant Kawalkar, Bangalore, (IN); Ramesh Chandrasekhar Raman, Bangalore (IN); Bijay Sinha, Bangalore (IN); Sai Nadipalli, Bangalore (IN)

(72) Inventors: Amit Nishikant Kawalkar, Bangalore, (IN); Ramesh Chandrasekhar Raman, Bangalore (IN); Bijay Sinha, Bangalore (IN); Sai Nadipalli, Bangalore (IN)

(73) Assignee: HONEYWELL INTERNATIONAL INC., Morristown, NJ (US)

(21) Appl. No.: 13/484,124

(22) Filed: May 30, 2012

(51) Int. Cl. G09G 5/00

(52) U.S. Cl. 345/629

(57) ABSTRACT

A system and method of protecting one or more objects rendered on a display device from being observed by an unwanted viewer. A primary object is rendered on the display device, and a privacy protection object is simultaneously rendered over at least a portion of the primary object. At least a portion of the privacy protection object is rendered with a color saturation value, a transparency value, and a phase delay relative to the primary object such that the portion of the primary object over which the privacy protection object is rendered is visibly obscured to a viewer that is located greater than a predetermined viewing distance from the display device and beyond a predetermined field of view of the display device.

### TECHNICAL FIELD

The present invention generally relates to privacy protection, and more particularly relates to systems and methods for protecting the privacy of objects rendered on a display.

### BACKGROUND

Advancements in processing and computing technology have led to increased demand for relatively small portable computing devices. These devices, which include devices such as tablet computers and smart phones, are becoming an integral part of many people's lives. Many of these portable devices are now able to run applications that, until recent years, could only be run on more traditional computing platforms, such as desktop or notebook (e.g., “laptop”) computing devices. These applications include, for example, web applications, email clients, graphic presentation software, advanced word processors, image editors, music production and editing applications, and various financial applications.

In many instances, when a computing device is implementing an application, the information being displayed on the computing device's display may be private. Some examples of private information include bank accounts, private emails, strategic business presentations, design blueprints, and family photos, just to name a few. Because this information can be readily observed by unsolicited viewers, many people are reticent to run certain applications on a portable computing device in public places. Moreover, improvements in display technology have increased the viewing angles of the displays on portable computing devices, making it easier for unwanted viewers to observe private information that may be displayed.

Various hardware-based solutions, such as privacy protector masks, have been developed to provide privacy protection for displayed information. A typical privacy protector mask comprises a transparent sheet of special material that limits the viewing angle of the display to which it is mounted or otherwise affixed. Such devices work on the principle of polarization, and thus offer privacy protection only from side viewing angles, and not vertical viewing angles. This further limits the use of physical privacy protectors in relatively crowded public areas, such as airports, on public transportation, and cafes, where viewing from a vertical direction is also possible. Moreover, single direction polarizers that have been mounted or affixed to a display device that is in landscape display mode do not work if the display device is switched to a portrait display mode. Physical privacy protectors also exhibit certain aesthetic drawbacks. For example, it can be fairly unattractive to mount or affix such devices on a tablet computer or smart phone. Such protectors can also reduce the brightness and overall display quality of display, leading a user to increase the brightness of the display, and concomitantly reducing the battery life. When mounted on or affixed to touch screen display devices, these privacy protectors can also reduce the touch screen sensitivity and smoothness, thereby degrading the user experience.

Although certain software solutions presently exist, these methods also exhibit drawbacks. For example, such solutions rely on relatively simple graphical patterns that can block a relatively large portion of the displayed content. Existing software solutions also do not compensate for the increase in stray visibility that can result from variations in the size and brightness of the displayed content.

Hence, there is a need for a method of providing privacy protection for objects that are rendered on a display that does not suffer the drawbacks of present methodologies. Namely, one that offers privacy protection from side and vertical viewing angles and/or is effective in regardless of portrait or landscape display mode and/or does not require a device to be mounted or affixed to the display device and/or does not reduce the brightness and overall display quality of display and/or does not reduce touch screen sensitivity and smoothness and/or can compensate for variations in the size and brightness of the rendered objects. The present invention addresses one or more of these needs.

### BRIEF SUMMARY

In one embodiment, a method of protecting one or more objects rendered on a display device from being observed by an unwanted viewer includes rendering a primary object on the display device, and simultaneously rendering a privacy protection object over at least a portion of the primary object. At least a portion of the privacy protection object is rendered with a color saturation value, a transparency value, and a phase delay relative to the primary object such that the portion of the primary object over which the privacy protection object is rendered is visibly obscured to a viewer that is located greater than a predetermined viewing distance from the display device and beyond a predetermined field of view of the display device.

In another embodiment, a computing system includes a display device and a processor. The display device is coupled to receive display commands and is configured, in response thereto, to render images thereon. The processor is in operable communication with the display device and is configured to supply display commands to the display device that cause the display device to render a primary object, and simultaneously render a privacy protection object over at least a portion of the primary object. At least a portion of the privacy protection object is rendered with a color saturation value, a transparency value, a size, and a phase delay relative to the primary object such that the portion of the primary object over which the privacy protection object is rendered is visibly obscured to a viewer that is located greater than a predetermined viewing distance from the display device and beyond a predetermined field of view of the display device.

Furthermore, other desirable features and characteristics of the privacy protection system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of one embodiment of a computing system 100;

FIGS. 2-4 depict top, side, and perspective views, respectively, of a representative definition of a field of view of a display device;

FIGS. 5A and 5B depict a privacy protection object implemented as a single contiguous object;

FIG. 6 graphically depicts representations of light waves corresponding to various objects being rendered on a display device;

FIGS. 7A and 7B depict a privacy protection object implemented as a plurality of geometric objects;

FIG. 8 depicts one of the geometric objects depicted in FIGS. 7A and 7B;

FIG. 9 depicts a method, in flowchart form, that may be implemented in the system of FIG. 1 to dynamically control the field of view (0) of a display device;

FIG. 10 depicts an alternative method, in flowchart form, for rendering privacy protection objects that may be implemented in the system of FIG. 1;

FIGS. 11A, 11B, and 12-18 depict various operations associated with a rendered privacy protection object that may be implemented when the system of FIG. 1 is implemented with a touch screen display device.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

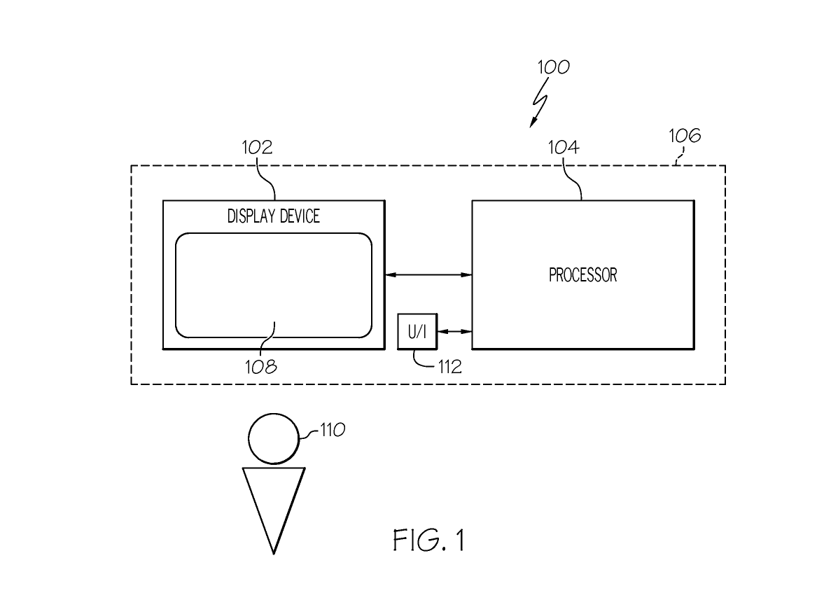

Referring to FIG. 1, a functional block diagram of one embodiment of a computing system 100 is depicted. The depicted computing system includes a display device 102 and at least one processor 104. In the depicted embodiment, the computing system 100 is implemented as a portable, hand-held device, and thus the display device 102 and processor 104 are disposed within the same housing 106. As such, the depicted computing system 100 may be implemented as any one of these device types including, for example, a tablet computer or a smart phone. It will be appreciated, however, that the computing system 100 could also be implemented as a notebook (or laptop) computer, as a desktop computer, or any one of numerous other computing systems that may not have the display device 102 and processor 104 in the same housing 106.

The display device 102 includes a display screen 108, and is in operable communication with, and receives display commands from, the processor 104. The display device 102 is configured, in response to the received display commands, to selectively render various textual, graphic, and/or iconic objects on the display screen, and thereby supply visual feedback to a user 110. It will be appreciated that the display screen 108 may be implemented using any one of numerous known display screens suitable for rendering textual, graphic, and/or iconic objects in a format viewable by the user 110. Some non-limiting examples of such display screens include various cathode ray tubes (CRT), and various flat screen display screens such as various types of LED (light emitting diode), LCD (liquid crystal display) and TFT (thin film transistor) display screens. The display device 102 may additionally be a panel mounted device, a HUD projection, or any known technology.

It is additionally noted that display device 102, at least in the depicted embodiment, is implemented as a touch screen device. As such, the display device 102 includes a touch sensitive region that is adapted to receive gesture-based input commands from the user 110. It is noted that the touch sensitive region is preferably, though not necessarily, collocated with the display screen 108. In either case, the touch sensitive region is configured, upon receipt of the gesture-based input commands, to generate command signals representative of the gesture-based input commands. As is generally known, gesture-based input commands, are commands that a user 110 inputs to a touch sensitive region of a display device 102 using one or more fingers. For example, a pinch-in gesture using two fingers (either on the same hand or on different hands) may correspond to a “zoom” command. It will be appreciated that the display device 102, when implemented as a touch screen device, may use any one of numerous types of touch screen displays configured to receive continuous touches from a user 110 that correspond to various gesture-based input commands.

The computing system 100 may additionally (or instead) include a user interface 112. The user interface 112, if included, is in operable communication with the processor 104 and is configured to receive input from the user 108. The user interface 112, in response to the user input, supplies commands signals to the processor 104. The user interface 112 may be any one, or combination, of various known user interface devices including, but not limited to, one or more buttons, switches, knobs, a mouse, or a keyboard (not shown).

The processor 104 may be implemented as a general-purpose processor using any one of numerous types of microprocessors. Although only one processor 104 is depicted, it will be appreciated that the system 100 could be implemented using two or more processors 104. It will additionally be appreciated that the processor 104 may be alternatively implemented. For example, it may be any implemented using any one of numerous conventional processors, controllers, microcontrollers, or state machines. The processor 104 may also be implemented as a combination of computational devices such as, for example, a combination of a digital signal processor (DSP) and a microprocessor, a plurality of microprocessors, one or more microprocessors in conjunction with a DSP core, or any one of numerous other combinations.

No matter how it is specifically implemented, the processor 104 is in operable communication with the display device 102 and, if included, the user interface 112. The processor 104 is coupled to receive the command signals supplied from display device 102 and/or the command signals supplied from the user interface 112. The processor 104 is configured, upon receipt of these command signals, to supply appropriate display commands to the display device 102 that cause the display device 102 to render various textual, graphic, and/or iconic objects on the display screen 108. The processor 104 is additionally configured, upon receipt of these command signals, to at least selectively supply various signals that will cause the display device 102 to render one or more privacy protection objects over at least portions of one or more of the textual, graphic, and/or iconic objects.

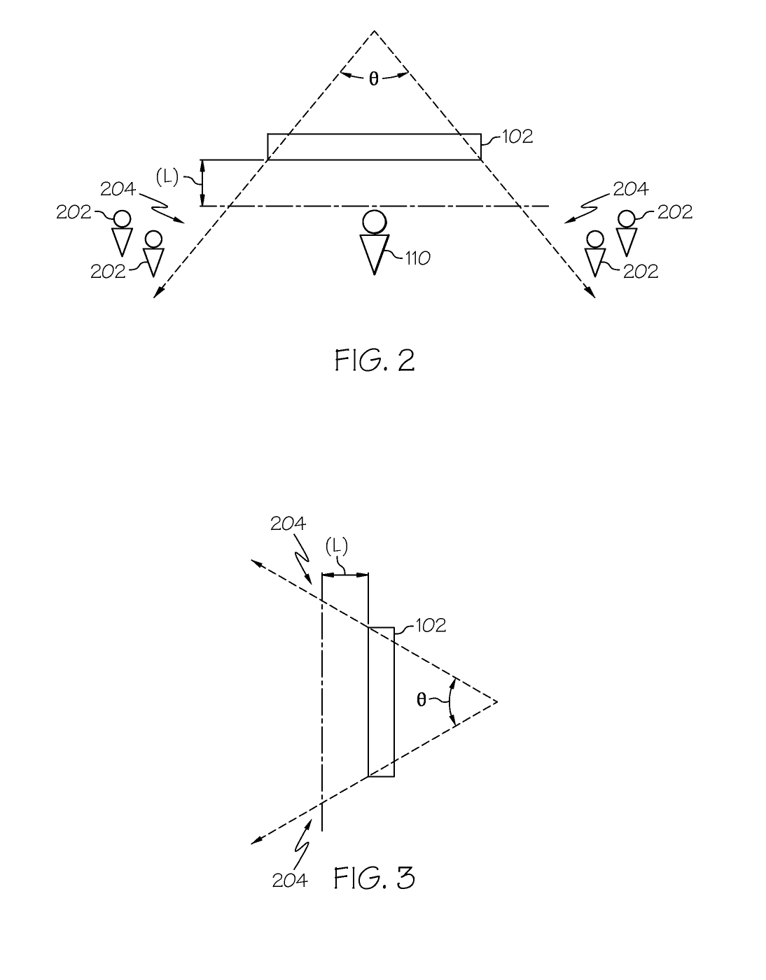

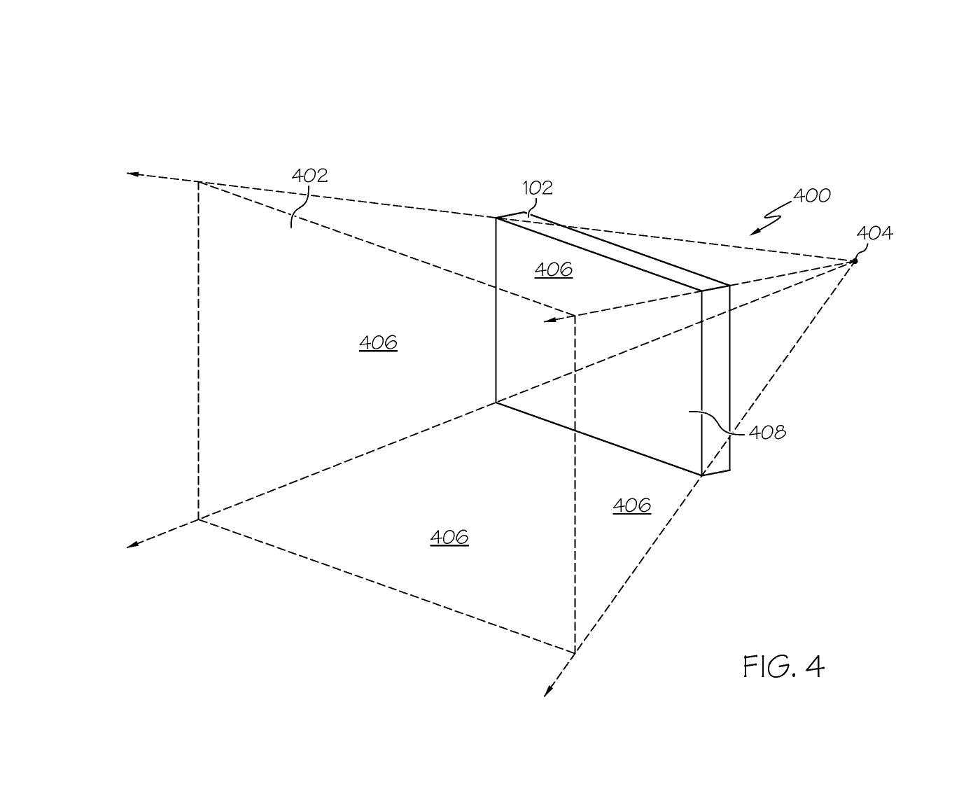

More specifically, and with reference now to FIGS. 2-4, the privacy protection object, when rendered on the display device 102, visibly obscures any portions of textual, graphic, and/or iconic objects over which the privacy protection object is rendered to certain viewers 202. These viewers 202 are those that are located within a privacy protection region 204. The privacy protection region 204 is defined as a region that is greater than a predetermined viewing distance (L) from the display device 102 and beyond a predetermined field of view (θ) of the display device 102. Before proceeding further, and as shown most clearly in FIG. 4, it is noted that the field of view (θ) of a display device 102, as is generally known, is defined as an imaginary rectangular-base prismatic volume 400, having a base 402, an apex 404, and four sides 406. The base 402 is located in front of the display device 102, the apex 404 is located behind the display device 102, and each side 404 extends along a different boundary of the display screen 108.

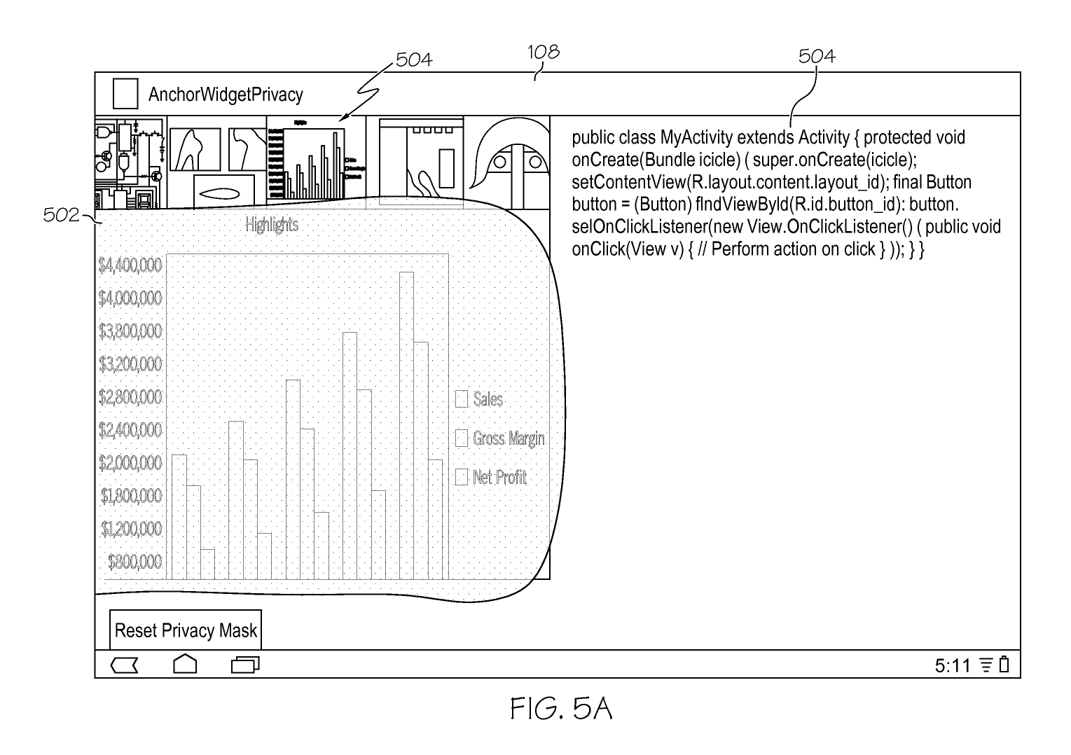

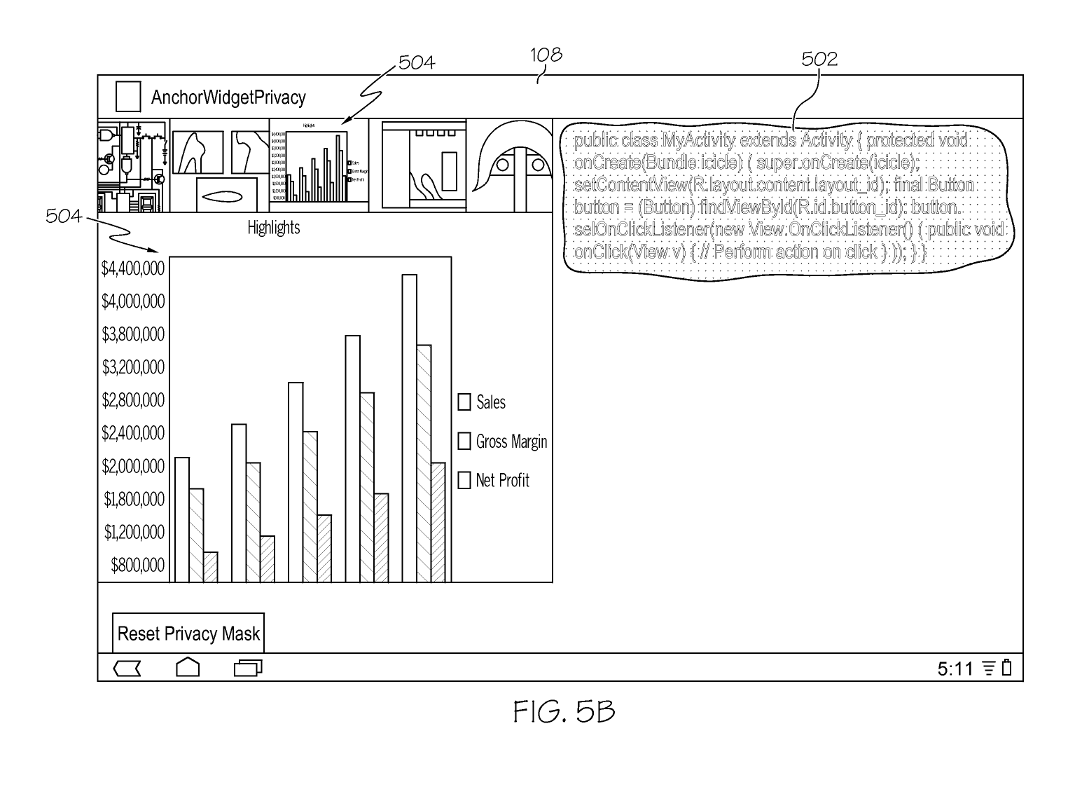

The privacy protection object may be implemented as either a single contiguous object or as a plurality of geometric objects separated by an intermediate region. A privacy protection object 502 implemented as a single contiguous object is depicted in FIGS. 5A and 5B. As FIGS. 5A and 5B further depict, the privacy protection object 502 is rendered over the textual, graphic, and/or iconic objects (or portions thereof) 504 for which privacy protection is desired. The privacy protection object 502 is basically a relatively plain, transparent layer. However, the brightness, color saturation value (Cs), transparency value (T), and phase (φ) relative to the underlying textual, graphic, and/or iconic objects 504 are selected so that the underlying textual, graphic, and/or iconic objects 504 are visibly obscured to any viewers 202 in the privacy protection region 204. Indeed, the size of the privacy protection region 204, and more specifically the size of the field of view (θ) of the display device 102, may be dynamically controlled by dynamically varying one or more of the color saturation value (Cs), the transparency (T), and relative phase (φ) of the privacy protection object 502.

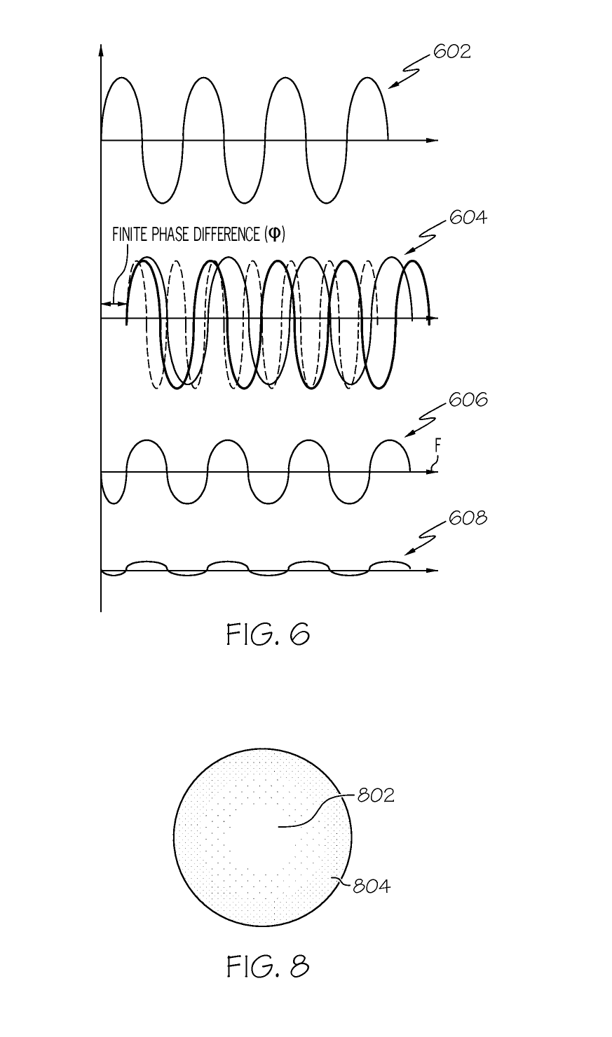

To fully understand the principle whereby the privacy protection object 502 of FIGS. 5A and 5B provides privacy protection, reference should be made to FIG. 6, which graphically depicts representations of light waves corresponding to various objects being rendered on the display device 102. In particular, light wave 602 corresponds to an underlying textual, graphic, and/or iconic object 504, and light wave 604 corresponds to the privacy protection object 502. It is noted that light wave 604 is brighter than light wave 602, is out of phase with light wave 602 by a finite phase difference (φ), and comprises equal levels of red (R), green (G), and blue (B) (e.g., is white light). Light wave 606 corresponds to the underlying textual, graphic, and/or iconic object 504 within the field of view (θ) and after passing through the privacy protection object 502, and light wave 608 corresponds to the underlying textual, graphic, and/or iconic object 504 outside of the field of view (θ) and after passing through the privacy protection object 502.

From the above and the graphs depicted in FIG. 6, it may be readily understood that because the light waves 606 that correspond to the privacy protection object 502 are relatively brighter than light waves 602 that correspond to underlying textual, graphic, and/or iconic objects 504, the light waves corresponding to the underlying textual, graphic, and/or iconic objects 504 are at least somewhat attenuated. However, because the light waves 606 that correspond to the privacy protection object 502 are white (e.g., comprise all colors) and are out of phase relative to the light waves 602 that correspond to underlying textual, graphic, and/or iconic objects 504, the light waves corresponding to the underlying textual, graphic, and/or iconic objects 504 are significantly attenuated outside of the field of view (θ) of the display device 102. Thus, the underlying textual, graphic, and/or iconic objects 504 are visually obscured to a viewer 202 located within the privacy protection region 204.

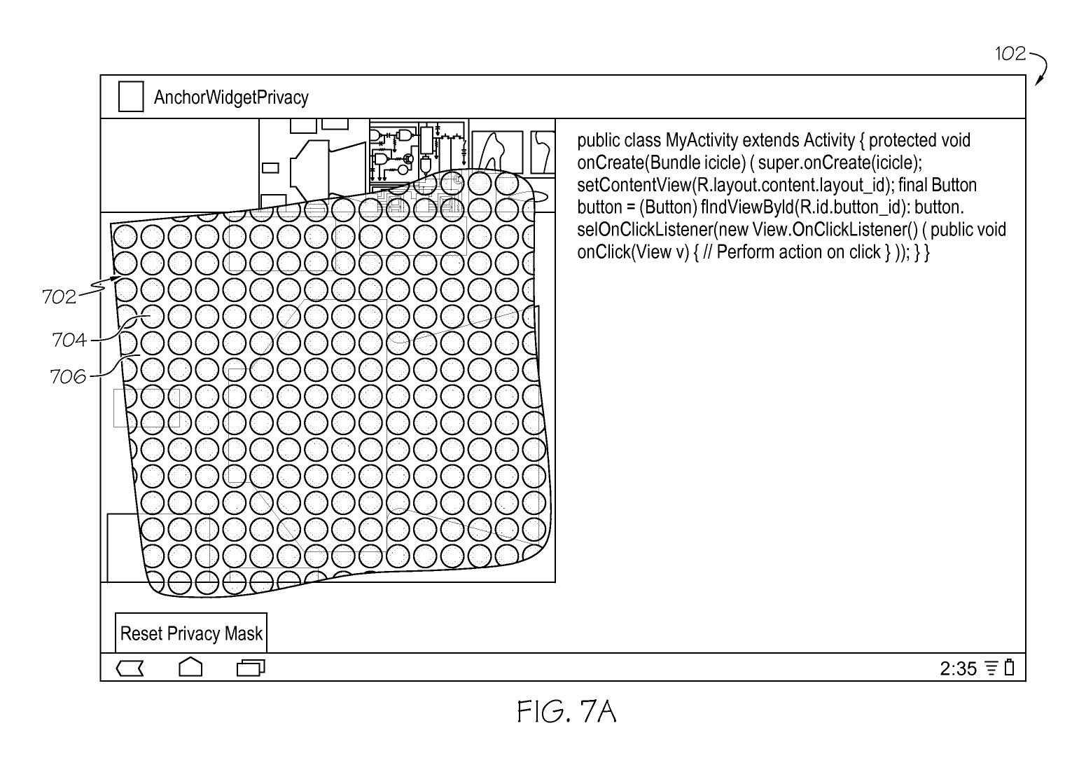

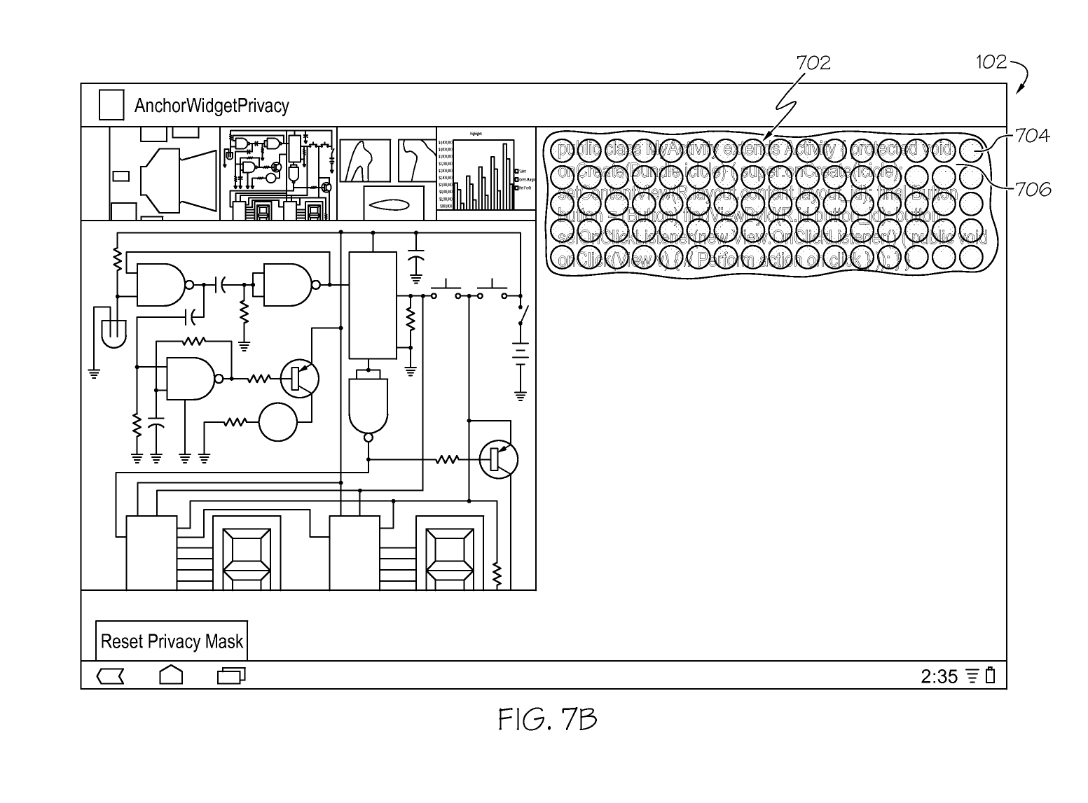

Turning now to FIGS. 7A and 7B, a privacy protection object 702 implemented as a plurality of geometric objects 704 separated by an intermediate region 706 will now be described. In the depicted embodiment, the geometric objects 704 are each circularly shaped and, as depicted more clearly in FIG. 8, each comprises a central region 802 and an outer region 804. It is noted that although each geometric object 704 in the depicted embodiment is circularly shaped, it will be appreciated that numerous other geometric shapes, such as square, hexagonal, diamond, rectangular, etc., may also be used.

No matter its particular shape, the central region 802 of each geometric object 704 is rendered with a transparency value of 100%. A transparency of 100% ensures that when the plurality of geometric objects 704 are rendered over textual, graphic, and/or iconic objects 504 to be protected, the intended user(s) 110 can clearly and readily view the graphical content. It will be appreciated that the area of the central region 802 and the overall size of this geometrical object may be a fixed, predetermined value, or it may be varied dynamically.

The outer region 804 of each geometric object 704 surrounds its corresponding central region 802. The outer region 804 of each geometric object is also preferably rendered with a relatively bright color (e.g. YELLOW, CYAN etc.), and with a transparency gradient that varies from 100% to a first transparency value that is less than 100%. This further increases the clarity of the underlying textual, graphic, and/or iconic objects 504 to the intended user(s) 110, while obscuring the visibility thereof to viewers 202 in the privacy protection region 204.

Returning to FIGS. 7A and 7B, the intermediate region 706 is rendered with a transparency value that is greater than or equal to the first transparency value. This has an effect of further obscuring the visibility of the underlying textual, graphic, and/or iconic objects 504 to viewers 202 in the privacy protection region 204. The overall effect is that, this method provides optimally maximum viewing clarity to the primary user and optimally maximum protection beyond field of view.

As with the previously described privacy protection object 502, various properties of the just-described privacy protection object 702 can be varied to control the size of the privacy protection region 204, and more specifically the size of the field of view (θ) of the display device 102. In particular, the field of view (θ) of the display device 102 can be controlled by varying one or more of: (1) the area of 100% transparent central region 802 (Rc); (2) the transparency of the intermediate region 706 (T); (3) the radial transparency of the outer region 804 (Tr) (e.g., the first transparency value); (4) the color saturation value of the geometric objects 704 (Ce); (5) the color saturation value of the intermediate region 706 (Cm); (6) the density of the geometric objects 704 (De); (7) the relative phase (φ) and (8) overall size of the geometric object.

In addition to variations of the parameters of the privacy protection objects 502, 702, the size of the privacy protection region 204 may also vary with certain parameters of the underlying textual, graphic, and/or iconic objects 504. These include the overall size of the underlying textual, graphic, and/or iconic objects 504, and the dynamic contrast between underlying textual, graphic, and/or iconic objects 504 and the privacy protection object 702. These parameters may vary during system 100 operation due, for example, to operator interaction. To counteract these unwanted changes in the field of view (θ), and thereby maintain the field of view (θ) relatively constant irrespective of the underlying textual, graphic, and/or iconic objects 504, the processor 102 may be configured to dynamically vary one or more of the controllable parameters of the corresponding privacy protection object 502, 702.

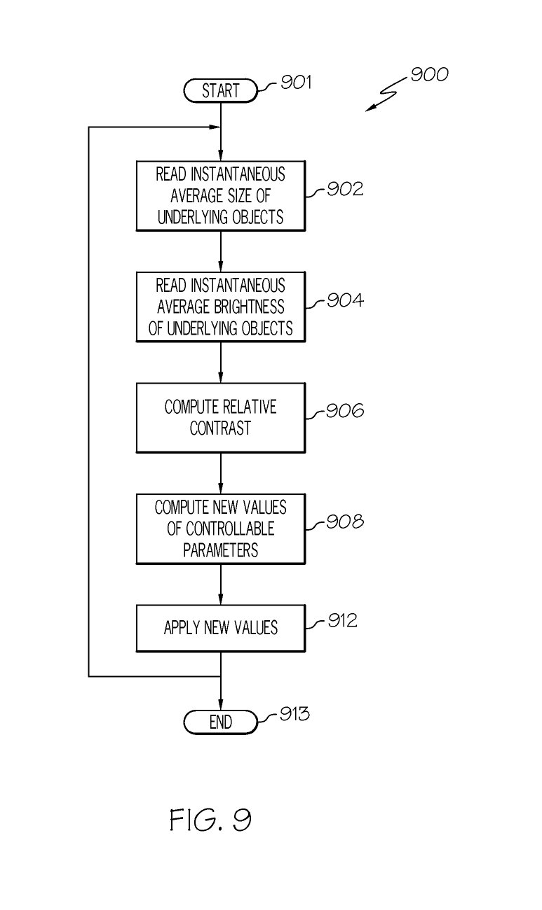

More specifically, and with reference to FIG. 9, a method implemented in the system 100 to dynamically control the field of view (θ) of the display device 102 is depicted in flowchart form, and will now be described. In describing the method 900, it is assumed that the processor 104 has commanded the display device 102 to render one of the privacy protection objects 502, 702 over at least a portion of one or more textual, graphic, and/or iconic objects 504. As depicted therein, the processor 104 determines the instantaneous average size of the underlying textual, graphic, and/or iconic objects 504 (902), the instantaneous average brightness of the underlying textual, graphic, and/or iconic objects 504 (904), and the overall relative contrast between the privacy protection object 502, 702 and the underlying textual, graphic, and/or iconic objects 504 (906). The processor 104 then computes new values of the controllable parameters (described above) associated with the privacy protection object 502, 702 being implemented (908). These new computed values are then applied (912).

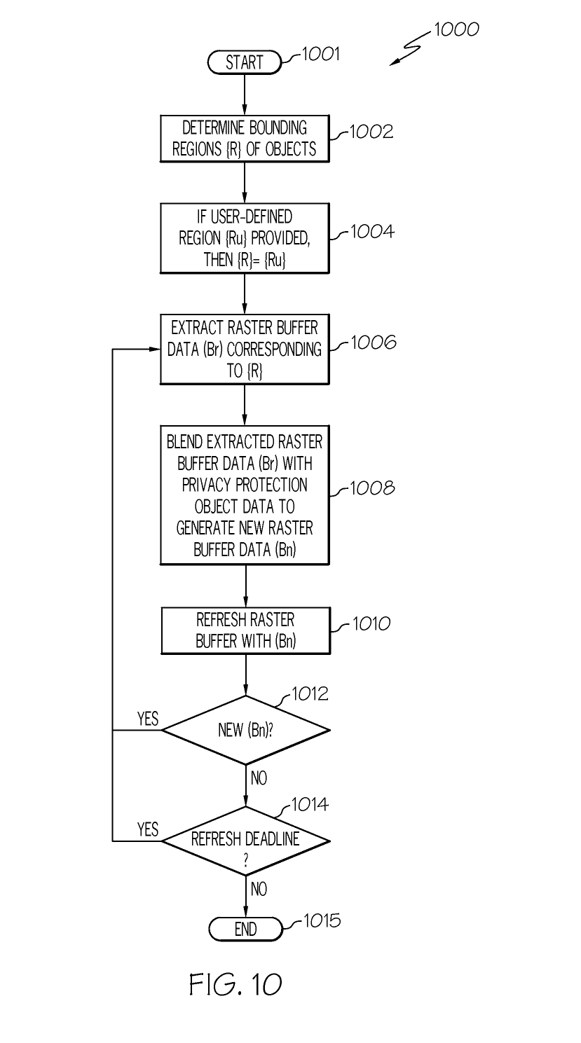

In the embodiments described thus far, the processor 104 has commanded the display device to render the privacy protection objects 502, 702 using what is referred to herein as a layered mode. With the layered mode, the processor 104 generates the privacy protection objects 502, 702 as graphical layer objects that are then separately rendered over the textual, graphic, and/or iconic objects 504 to be protected. However, the processor 104 may also be configured to implement what is referred to herein as a non-layered mode. With the non-layered mode, the processor 104 processes the privacy protection object 502, 702 together with the textual, graphic, and/or iconic objects 504 at the pixel level. With reference to FIG. 10, a flowchart of the generalized methodology carried out by the processor 104 when implementing the non-layered mode is depicted, and will now be described.

The processor 104 first determines the bounding regions {R} of the textual, graphic, and/or iconic objects 504 for which privacy protection is to be provided (1002). These regions may be combined together or kept distinct, based on the user configuration. As may be appreciated, the user 110 may also define a bounding region {Ru} for the textual, graphic, and/or iconic objects 504 using, for example, the user interface 112 or the touch screen display (if so implemented). If so, then the user-defined bounding region {Ru} overrides the processor-determined bounding region {R} (e.g., {R}←{Ru}) (1004).

The processor 104 then extracts raster buffer data (Br) that corresponds to the bounding region {R} (1006), and blends these extracted data (Br) with the privacy protection object 502, 702 using any one of numerous known data blending methods to generate new raster buffer data (Bn) (1008). The processor 104 then refreshes the raster buffer that corresponds to the bounding region {R} with the new raster buffer data (Bn) (1010).

The previous methodological steps (1002-1010) are repeated, if there is change in the raster buffer that corresponds to region {R} due to, for example, a user-initiated operation (1012), or if a periodic raster buffer refresh deadline is reached (1014).

It was previously noted that in some embodiments the display device 102 may implemented as a touch screen device that includes a touch sensitive region adapted to receive gesture-based input commands from the user 110. For such embodiments, the processor 104 may also be configured, in response to gesture-based input commands supplied to the touch sensitive region, to implement numerous and varied operations associated with the privacy protection object 502, 702. Some of these operations will now be described.

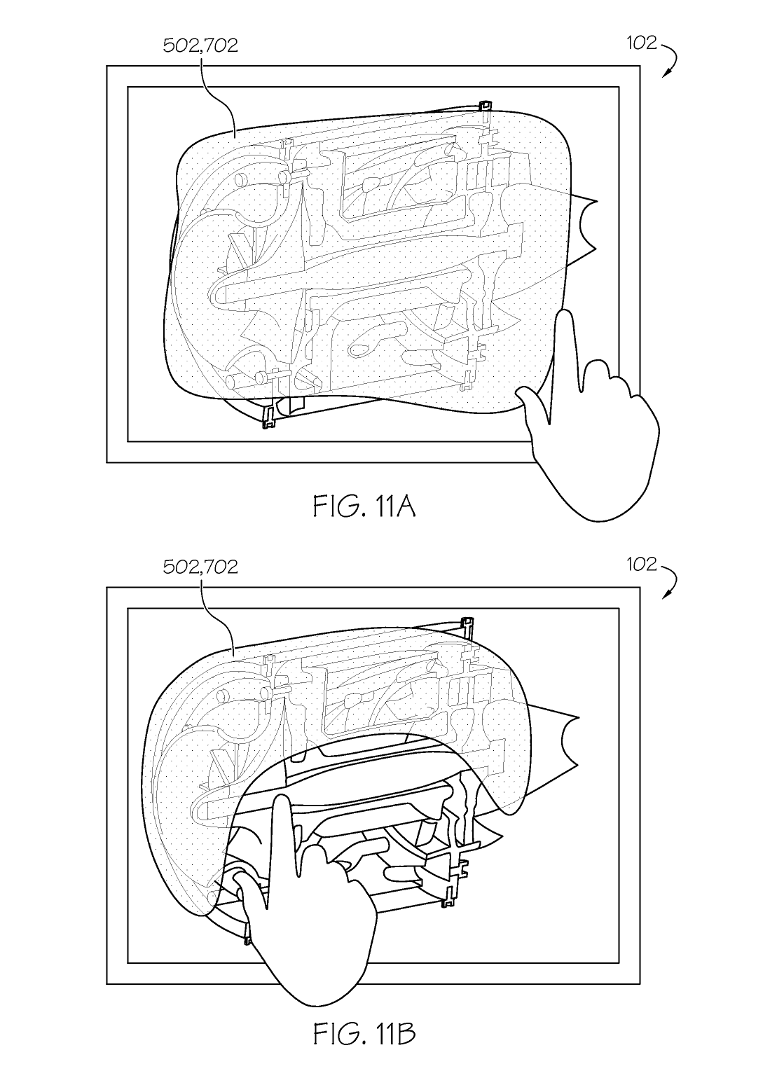

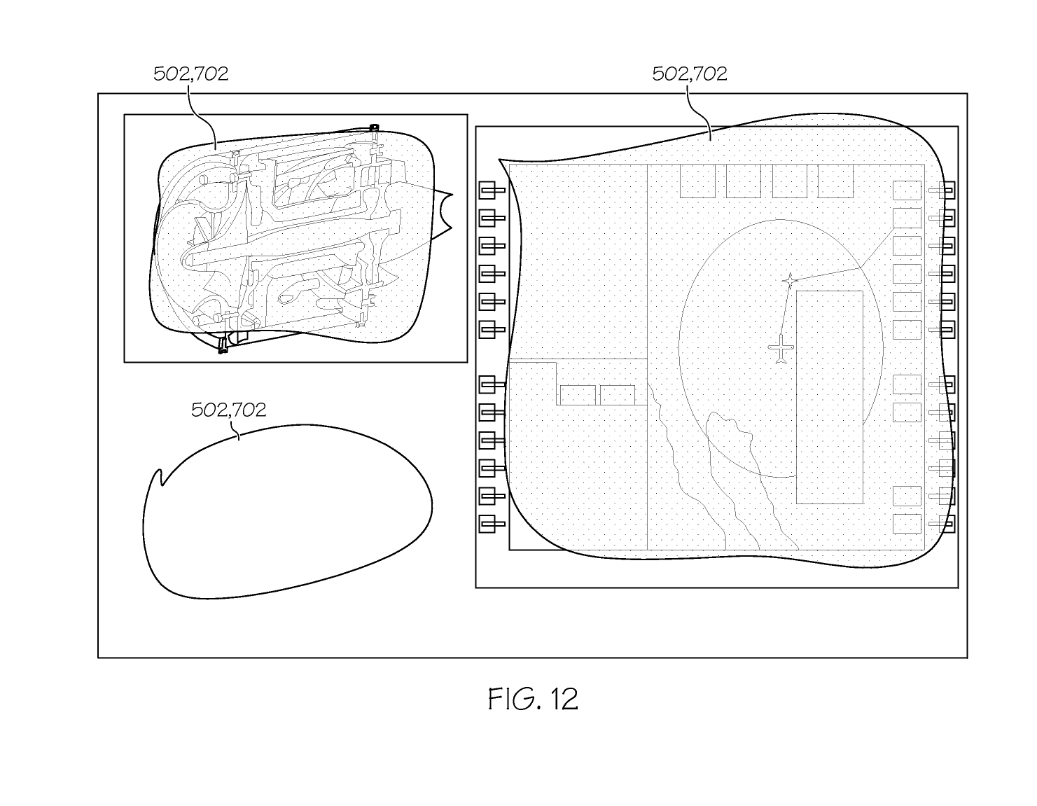

The system 100 may be configured to control the size and shape of the privacy protection object 502, 702. For example, as depicted in FIGS. 11A and 11B, the user 110 could increase or decrease the overall size of the privacy protection object 502, 702 or “wipe off” portions the privacy protection object 502, 702 using single or multiple fingers. As depicted in FIG. 12, the user 110 could command the system 100 to render multiple privacy protection objects 502, 702 on the display screen 108 to provide privacy protection for distinct instances of textual, graphic, and/or iconic objects 504 that are also rendered. As may be appreciated, the system 100 may also be configured so that the user 110 may independently control each of the different privacy protection objects 502, 702.

As may be appreciated, if a user 110 (or other person) were to inadvertently touch the screen, the privacy protection object 502, 702 could be inadvertently moved, resulting inadvertent removal of privacy protection. Thus, the system 100 may also be configured to allow a user 110 to lock the privacy protection object 502, 702 at a particular location. The manner in which the system 100 may be configured to implement this functionality may vary, but in the depicted embodiment, as illustrated in FIG. 13, the processor 104 may be configured to command the display device 102 to render a “LOCK” widget 1302. The user 110 may then be able to selectively lock and unlock the privacy protection object 502, 702 via successive touches of the “LOCK” widget 1302.

As an add-on to the locking functionality described above, the system 100 may also be configured so allow the user 110 to interact with the underlying textual, graphic, and/or iconic objects 504 when the privacy protection object 502, 702 is locked. In particular, when the privacy protection object 502, 702 is locked, as described above, any subsequent single- or multi-touch gesture-based input commands are applied to the underlying textual, graphic, and/or iconic objects 504. This allows the user 110 to interact with the underlying graphical elements improving the usability of the proposed privacy protector objects.

In some embodiments the system 100 may also be configured to implement a single-gesture command direct interface to vary the characteristics of the rendered privacy protection object 502, 702. For example, if the user 110 were to apply a continuous touch to the rendered privacy protection object 502, 702, the system 110 may be configured to increase the visibility of the underlying textual, graphic, and/or iconic objects 504.

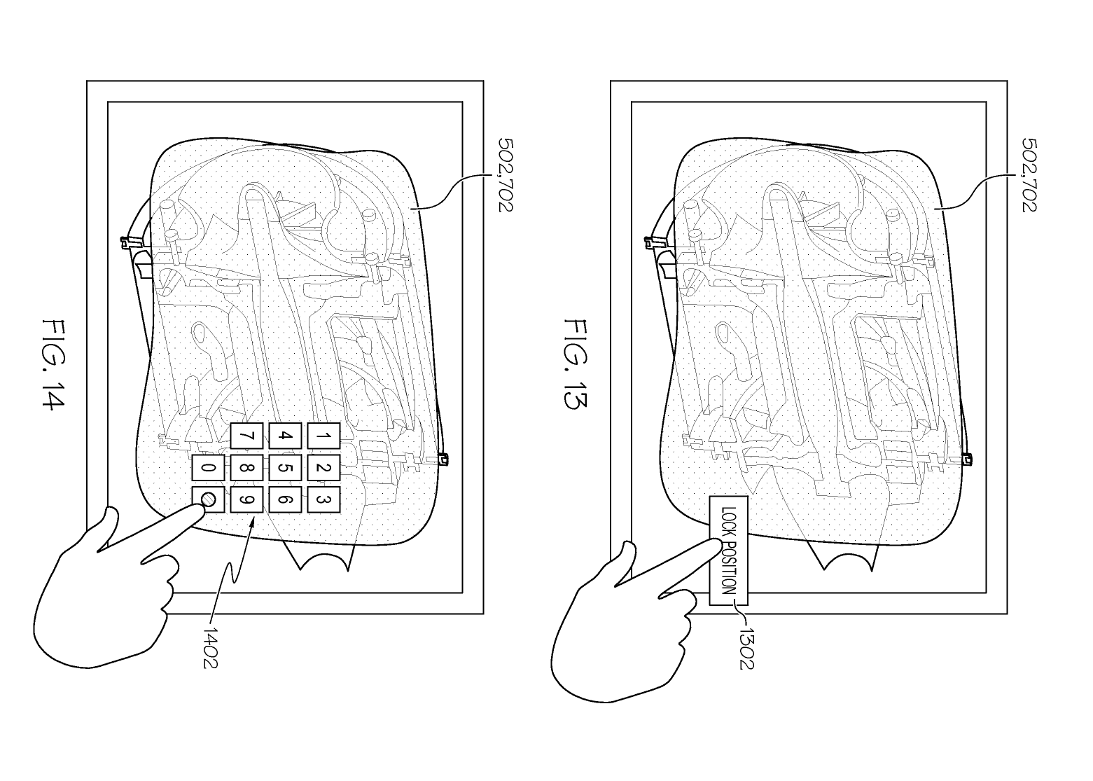

The system 100 may also be configured to implement password protection of a privacy protection object 502, 702. The manner in which the system 100 may be configured to implement this functionality may vary, but in the depicted embodiment, the processor 104 may be configured to command the display device 102 to render the previously described “LOCK” widget 1302. In addition, however, when the user 110 presses the “LOCK” widget 1302 to place the privacy protection object 502, 702 in the locked state, the processor 104 is configured to command the display device to render, for example, a numeric keypad, such as the exemplary keypad 1402 depicted in FIG. 14. The user 110 may interact with the numeric keypad 1302 to enter a desired password.

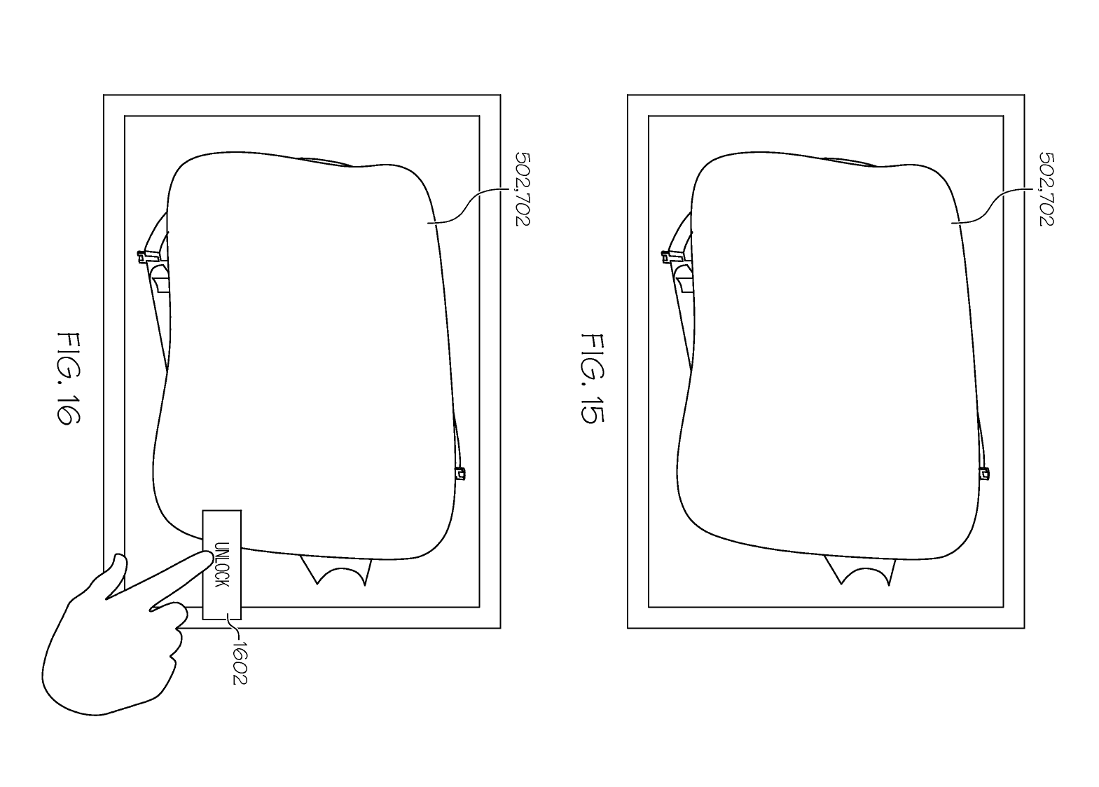

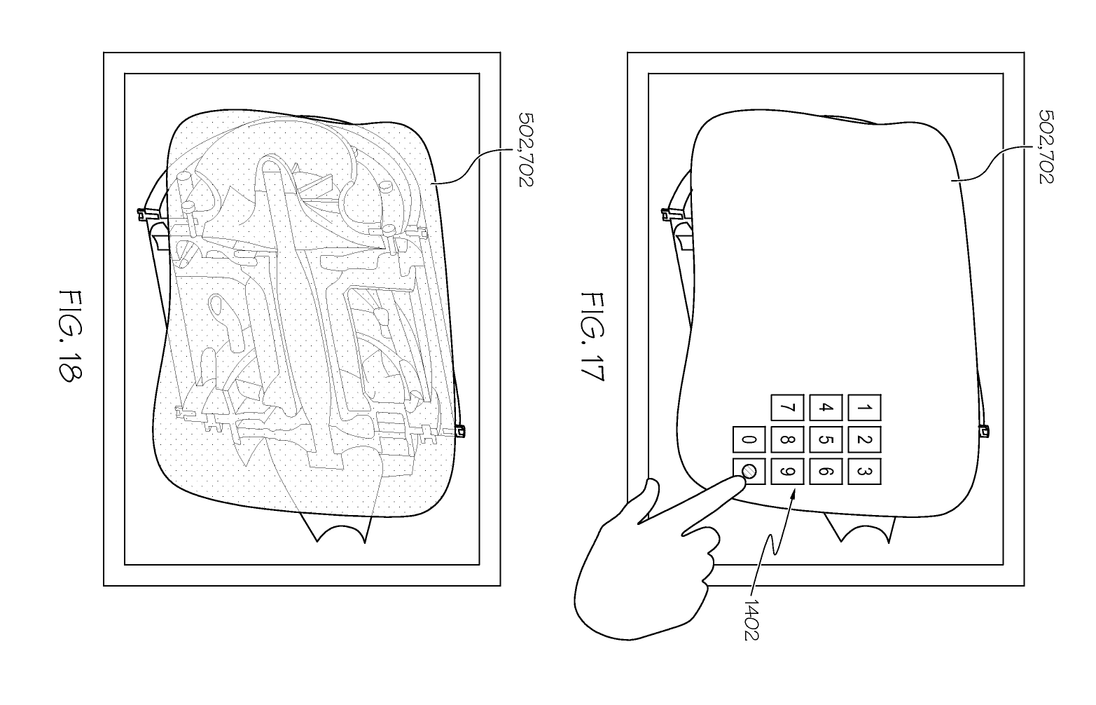

As depicted in FIG. 15, when the user 110 places the privacy protection object 502, 702 in the locked state and enters the appropriate password, the processor 104 may, in some embodiments, be configured to render the privacy protection object 502, 702 in a manner that it completely obscures the underlying textual, graphic, and/or iconic objects 504. Thereafter, and as shown in FIGS. 16-18, when the user 110 subsequently unlocks the privacy protection object 502, 702, via an “UNLOCK” widget 1602 and the numeric keypad 1402, the privacy protection object 502, 702 would be rendered in a manner that the underlying textual, graphic, and/or iconic objects 504 are visible to the user 110. (Excellent)

The system 100 may also be configured to implement a “sticky” privacy protection object 502, 702. When so configured, a user 110 can “stick” a privacy protection object 502, 702 to specific textual, graphic, and/or iconic objects 504. In so doing, the “stuck” privacy protection object 502, 702 follows the underlying textual, graphic, and/or iconic objects 504.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of protecting one or more objects rendered on a display device from being observed by an unwanted viewer, the method comprising the steps of:
rendering a primary object on the display device; and
simultaneously rendering a privacy protection object over at least a portion of the primary object, at least a portion of the privacy protection object rendered with a color saturation value, a transparency value, and a phase delay relative to the primary object such that the portion of the primary object over which the privacy protection object is rendered is visibly obscured to a viewer that is located greater than a predetermined viewing distance from the display device and beyond a predetermined field of view of the display device.

2. The method of claim 1, wherein the privacy protection object comprises:
a plurality of geometric objects; and
an intermediate region between each of the geometric objects.

3. The method of claim 2, wherein each of the geometric objects is circularly shaped.

4. The method of claim 2, wherein each of the geometric objects comprises:
a central region is rendered with a transparency value of 100%; and
an outer region surrounding the central region, the outer region rendered with transparency gradient that varies from 100% to a first transparency value that is less than 100%.

5. The method of claim 4, wherein the intermediate region is rendered with a transparency value that is greater than or at least equal to the first transparency value.

6. The method of claim 1, further comprising:
determining a size of the primary object;
determining a relative contrast of the primary object and the privacy protection object; and
based on the determined size and determined relative contrast, varying the color saturation value, the transparency value, size of the geometrical object and the phase delay to maintain the predetermined viewing distance and predetermined viewing angle.

7. The method of claim 1, wherein:
the display device comprises a gesture-based touch screen display; and
the method further comprises defining a size and a shape of the privacy protection object in response to a user supplying gesture-based input commands on the touch screen display.

8. The method of claim 7, further comprising:
receiving, on the touch screen display, gesture-based input commands from a user that remove at least a portion of the privacy protection object.

9. The method of claim 1, further comprising:
selectively locking and unlocking a position of the privacy protection object in response to a user supplying gesture-based input commands on the touch screen display.

10. The method of claim 1, further comprising:
receiving, on the touch screen display, gesture-based input commands from a user that represent a user-defined password entry; and
selectively locking and unlocking the position of the privacy protection object upon entry of the user-defined password.

11. The method of claim 10, further comprising:
when the position of the privacy protection object is locked, visibly obscuring the portion of the primary object over which the privacy protection object is rendered to viewers at all distances and all viewing angles.

12. The method of claim 10, further comprising:
determining when the position of the privacy protection object is locked; and
varying one or more characteristics of the primary object in response to a user supplying gesture-based input commands on the touch screen display.

13. The method of claim 12, further comprising:
varying one or more characteristics of the privacy protection object to thereby vary visibility of the primary object, in response to receiving, on the touch screen display, gesture-based input commands from a user.

14. The method of claim 1, wherein the primary object and the privacy protection object are independently rendered.

15. The method of claim 1, wherein the primary object and the privacy protection object are simultaneously processed and rendered at a pixel level.

16. A computing system, comprising:
a display device coupled to receive display commands and configured, in response thereto, to render images thereon; and
a processor in operable communication with the display device and configured to supply display commands to the display device that cause the display device to:
render a primary object, and
simultaneously render a privacy protection object over at least a portion of the primary object,
wherein at least a portion of the privacy protection object is rendered with a color saturation value, a transparency value, a size, and a phase delay relative to the primary object such that the portion of the primary object over which the privacy protection object is rendered is visibly obscured to a viewer that is located greater than a predetermined viewing distance from the display device and beyond a predetermined field of view of the display device.
